(19) United States
(12) Patent Application Publication
(10) Pub. No.: US 2003/0156090 A1
(43) Pub. Date: Aug. 21, 2003

(54) Bistable liquid crystal display having a remote display update control

(76) Inventors: Jason Drury Munn, West Covina, CA (US); Scott Wayne Ferguson, Arcadia, CA (US); James Spencer Wolff, Sierra Madre, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/171,106

(22) Filed: Jun. 13, 2002

Related U.S. Application Data
(60) Provisional application No. 60/358,127, filed on Feb. 20, 2002.

(51) Int. Cl. G09G 3/36

(52) U.S. Cl. 345/97

(57) ABSTRACT

A method and apparatus for displaying information by a liquid crystal display is provided. A bistable liquid crystal display is coupled to a signal input to provide a display device. A user device is provided remote from the display device for controlling the bistable liquid crystal display. The user device has a signal output coupled to a driver control. The driver control is responsive to a user input controlled by a user to display the information by the liquid crystal display. The display device is electrically interconnected with the user device by coupling the signal output to the signal input through a signal interface.

### CROSS-REFERENCE TO RELATED APPLICATION

This application claims priority to and benefit of U.S. Provisional Patent Application No. 60/358,127 filed on Feb. 20, 2002.

### BACKGROUND OF THE INVENTION

The present invention relates to the field of electronic displays, and, in particular, to a bistable liquid crystal display system having a remote display update control.

In many commercial establishments, such as those frequented by the general public consumers, products being sold typically have informational displays presented in association with a purchasable product or service. For example, in a grocery store, hardware store, electronics goods store, or the like, product pricings frequently are displayed on signage located on a shelf, booth, cabinet, etc. adjacent to the product display or service area. While paper or other printed media are well-known display methodology, modern electronic displays are becoming more prevalent, and are commonly termed electronic shelf labels.

One example of such an electronic shelf label and related system is shown in International Publication Number WO 0067/67100 of inventors Comiskey et al., hereinafter “Comiskey”, wherein an updateable encapsulated bistable electrophoretic display medium (“electronic ink”) situated in an display unit is in electrical communication with an information updating unit which updates information displayed by the display unit in response to a control signal. In one embodiment a sensor, such as a microphone or optical sensor, is in communication with an information updating unit for updating information displayed based upon data received by the sensor. In another embodiment, a portable activation device having a radio antenna transmits data receptive by a radio receiver sensor for updating display information. As can be seen in Comiskey, the updating unit includes a logic circuit that updates the information displayed based on and in response to the update signal. In one preferred embodiment the information updating unit including the logic circuit is integrated with the electronic display unit on a common substrate. In a preferred embodiment the logic circuit contains embedded software, such as event scheduling, communication modules, error handling, script interpreting, such embedded software requiring signal processing to execute the software commands. Accordingly, the Comiskey display unit is complex and as a result costly.

Another example of an electronic shelf label and related system is shown in U.S. Pat. No. 5,548,282 entitled Electronic Shelf Edge Price Display System, issued to Escritt et al., hereinafter “Escritt”, wherein electronic display units receive data packets transmitted from a control transmitter, including wireless transmission, are inductively coupled into the display unit wherein microprocessors (which are notably an integral part of each display unit) are needed to process such data packets. Accordingly, the Escritt specific display unit is also a complex and costly device.

Given commercial establishments wherein multiple complex and expensive display units are located throughout a store, such prior art electronic display systems can provide electronic shelf labels, albeit an overall expensive store-wide system for the commercial enterprise. A need therefore exists for simple cost-effective electronic display unit and related implementation system, including a display unit which has greatly reduced power needs on the display unit thereby providing the ability to have lower priced individual display units. The present invention provides a solution to meet such need.

### SUMMARY OF THE INVENTION

In accordance with the present invention a method and apparatus for displaying information by a liquid crystal display is provided. A bistable liquid crystal display is coupled to a signal input to provide a display device. A user device is provided remote from the display device for controlling the bistable liquid crystal display. The user device has a signal output coupled to a driver control. The driver control is responsive to a user input controlled by a user to display the information by the liquid crystal display. The display device is interconnected with the user device by coupling the signal output to the signal input through a signal interface.

In one embodiment the bistable liquid crystal display is a cholesteric liquid crystal display. The driver control provides matrix addressing signals to the bistable crystal display in response to the user input. The user device is a hand held device with the user input being a keypad.

In accordance with the present invention, in one embodiment the signal input can a first connector. The signal output can be a second connector. The signal interface can be a connector mating interface. The display device is interconnected with the user device by mating the first connector with the second connector at the connector mating interface such that driver control signals from the driver control are provided to the liquid crystal display through a mated connection of the first connector with the second connector.

In another embodiment, the signal input can a wireless receiver, the signal output is a wireless transmitter and the signal interface is a transmission medium, and the interconnecting the display device with the user device is by transmitting by the wireless transmitter driver control signals from the driver control over a transmission medium to the wireless receiver coupled to the liquid crystal display. The wireless transmitter and wireless receiver can respectively transmit and receive radio frequency signals. The wireless transmitter and wireless receiver can respectively alternatively transmit and receive infrared signals. The wireless transmitter and wireless receiver can respectively transmit and receive audio signals.

In accordance with another aspect of the present invention, information is displayed by a liquid crystal display by mounting a display rail to a product shelf. The display rail is adapted for removably mounting thereon a liquid crystal display. A display controller is mounted to the product shelf. The display controller is responsive to a user input controlled by a user to display information by the liquid crystal display. The display controller is electrically interconnected to the display rail to provide display control information to the liquid crystal display.

In still another aspect of the present invention information can be displayed by a plurality of liquid crystal displays by mounting a plurality of display rails to a product shelf. Each display rail is adapted for removably mounting thereon a liquid crystal display. A display controller can be mounted to the product shelf. The display controller is responsive to a user input controlled by a user to display information by the liquid crystal displays. The display controller electrically interconnects to each display rail through one or more display rail electrical interconnectors to provide display control information to each liquid crystal display.

### BRIEF DESCRIPTION OF THE DRAWINGS

FIG. 1 shows a liquid crystal display in accordance with the present invention.

FIGS. 2A and 2B depict matrix addressing of a simplified liquid crystal display structure.

FIG. 3 shows in simplified block diagram form an embodiment of the present invention.

FIGS. 4A and 4B depict variations of the signal interface in accordance with the present invention.

FIGS. 5A-5C depict an embodiment of the present invention implementing connector contacts.

FIG. 6 shows a typical simplified commercial product display and its product display signage which can make use of the present invention.

FIGS. 7A-7D show an exemplary embodiment utilizing the LCD display panel in accordance with the present invention implemented in conjunction with the simplified commercial product display of FIG. 6.

FIG. 8 shows an exemplary embodiment of an LCD display panel.

FIG. 9 shows an exemplary embodiment of an LCD display panel assembled with an display rail.

FIGS. 10A-10E depict an assembly sequence for the LCD panel display assembly onto a shelf.

FIGS. 11A and 11B show another exemplary embodiment of the present invention wherein display rails can be linked together to drive many displays with the same display controller.

FIGS. 12A and 12B show the relationships and processing for shelf mounted display systems involving either a segmented display or a matrix display.

FIG. 13 shows a segmented LCD display panel in accordance with the present invention.

FIG. 14 shows a matrix LCD display panel in accordance with the present invention.

### DETAILED DESCRIPTION

A liquid crystal display (LCD) is a type of flat panel display used in various electronic devices. Cholesteric LCDs are bi-stable devices which are capable of maintaining a display image state after an applied voltage is removed. Such cholesteric LCDs are known to those skilled in the art, as can be seen from U.S. Pat. Nos. 5,625,477, 5,661,533, 5,796,454, 5,825,451, 5,889,566, 5,933,203 and 5,949,513 assigned to Advance Display Systems, Inc. (ADS) of Richardson, Tex.

In the typical LCD, Off-state (opaque) incident light to an LCD cell is backscattered in the absence of an electric field applied across the LCD. In an On-state (transparent) application of an electric field aligns the liquid crystals in the LCD cell and incident light traverses the cell.

As can be seen from the above-referenced ADS patents, with a cholesteric LCD the molecular alignment of the crystals in a series of parallel planes perpendicular to an axis changes spirally along the LCD cell axis in the presence (On-state) of an electric field applied along the axial direction. The direction of molecular alignment rotates in each successive parallel plane along the axis, creating a helical structure of the molecular alignment. The helical structure serves as a diffraction grating for visible light. When an electric field (greater than a critical field) is applied between transparent electrodes at the ends of the LCD cell axis, the helical twist is destroyed as molecules align parallel to the field, so that the rotation of the light's plane of polarization cannot be sustained. Using crossed polarizers and a backing mirror, the crossed polarizers effectively block reflection of the incident light from the backing mirror, the surface appearing to be dark with excellent contrast to the device in the reflecting (bright)mode. Given the bi-stable nature of the cholesteric LCD they remain polarized in one state, not allowing light to pass through and be reflected back, even when the applied electric field is removed.

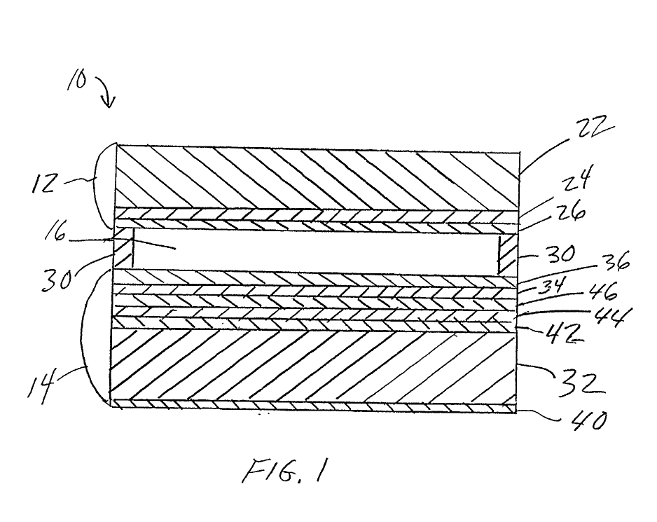

Referring to FIG. 1, an LCD implemented in accordance with the present invention is described and shown in more detail. Generally, LCDs comprise two sheets of polarizing material with a liquid crystal solution therebetween. Each sheet of polarizing material typically comprises a substrate of glass or transparent plastic. The liquid crystal (LC) is used as optical switches. The substrates are usually manufactured with transparent electrodes, typically made of indium tin oxide (ITO), to which electrical “driving” signals are coupled. The driving signals induce an electric field which can cause a phase change or state change in the LC material. The LC exhibits different light-reflecting characteristics according to its phase and/or state.

Liquid crystals may be nematic, smectic or cholesteric depending upon the arrangement of the molecules. A twisted nematic cell is made up of: two bounding plates (usually glass slides), each with a transparent conductive coating (such as ITO) that acts as an electrode, spacers to control the cell gap, two crossed polarizers (the polarizer and the analyzer), and nematic liquid crystal material. Twisted nematic displays rotate the director of the liquid crystal by 90°. Super-twisted nematic displays employ up to a 270° rotation. This extra rotation gives the crystal a much steeper voltage-brightness response curve and also widens the angle at which the display can be viewed before losing much contrast. Cholesteric liquid crystal (CLC) displays are normally reflective (meaning no backlight is needed) and can function without the use of polarizing films or a color filter. “Cholesteric” means a type of liquid crystal having finer pitch than that of twisted nematic and super twisted nematic. Sometimes it is called “chiral nematic” because cholesteric liquid crystal is normally obtained by adding chiral agents to host nematic liquid crystals. Cholesteric liquid crystals may be used to provide bi-stable and multi-stable displays that, due to their non-volatile “memory” characteristic, do not require a continuous driving circuit to maintain a display image, thereby significantly reducing power consumption.

Still referring to FIG. 1, the general structure of a LCD device 10 is shown in cross-sectional view. The LCD device 10 includes a front panel 12 and a back panel 14, with a layer of liquid crystal material 16 between the panels 12 and 14. The front panel 12 may include a front substrate 22, front electrodes 24, and a front alignment or orientation coating or layer 26. A seal ring 30 joins the front panel 12 and the back panel 14, and retains the liquid crystal material 16 between the front panel 12 and the back panel 14. The back panel 14 may include a back substrate 32, back electrodes 34, a back alignment or orientation coating or layer 36, an outer-side protective layer 40, a back barrier layer 42, an opaque layer 44, and an internal protective layer 46.

The front substrate 22 and back substrate 32 may be rigid substrates. For example, the front substrate 22 and back substrate 32 may be a glass substrate. The glass may be a conventionally-available glass, for example having a thickness of approximately 0.2-1 mm. Alternatively, the front substrate 22 and back substrate 32 may be made of other suitable transparent materials, such as a rigid plastic or a plastic film. An optically transparent thermoplastic polymeric material may be used for the front substrate 22 and/or back substrate 32. Examples of suitable such materials are polycarbonate, polyvinyl chloride, polystyrene, polymethyl methacrylate, polyurethane polyimide, polyester, and cyclic polyolefin polymers. More broadly, the back substrate 32 may be a flexible plastic such as a material selected from the group consisting of polyether sulfone (PES), polyethylene terephthalate (PET), polyethylene naphthalate, polycarbonate, polybutylene terephthalate, polyphenylene sulfide (PPS), polypropylene, aramid, polyamideimide (PAI), polyimide, aromatic polyimides, polyetherimide, acrylonitrile butadiene styrene, and polyvinyl chloride. Further details regarding substrates and substrate materials are known to those skilled in the art, as seen from International Publication Nos. WO 00/46854, WO 00/49421, WO 00/49658, WO 00/55915, and WO 00/55916.

The electrodes 24 and 34 may include commonly-known transparent conducting oxides, such as indium tin oxide (ITO). It will be appreciated that other metal oxides may be employed, such as indium oxide, titanium oxide, cadmium oxide, gallium indium oxide, niobium pentoxide, and tin oxide. In addition to a primary oxide, the electrodes may include a secondary metal oxide such as an oxide or cerium, titanium, zirconium, hafnium, and/or tantalum. The possible transparent conductive oxides include ZnO2, Zn2SnO4, Cd2SnO4, Zn2In2O5, MgIn2O4, Ga2O3—In2O3, and TaO3. The electrodes 24 and 34 may be arranged on the inside surface of the substrates 22 and 32 in either a segmented or X-Y matrix design, as is well known in the art, to form a plurality of picture elements (pixels). The electrodes 24 and 34 may be formed, for example, by low temperature sputtering or direct current sputtering techniques (DC-sputtering or RF-DC sputtering), followed by selective removal of material. Although only a few electrodes are shown, in practice a large number of electrodes are incorporated in the cell and the number will generally increase as the area dimensions of the cell increase. The electrodes 24 and 34 may have leads which are connected to bus leads, which in turn are connected to addressing electronics described in more detail below. The electrodes 24 and 34 may be addressed independently to create an electric field at selected pixels. In some addressing schemes, the electrodes are sequentially and repeatedly scanned at a rapid rate to provide moving images similar to television images. This requires “refreshing” the display at short time intervals to rapidly turn pixels on and off.

In an exemplary embodiment, the electrodes 24 and 34 may each have a width of 200 microns, with a 20 micron gap between electrodes, thus resulting in a display having pixels that are 200 microns by 200 microns in size, although it will be appreciated that other electrode sizes and gap sizes may be employed. The electrodes may have a sheet resistance of less than about 60 ohms.

The back electrodes 34 alternatively may be opaque electrodes, such as copper or aluminum electrodes. More broadly, the back electrodes may be elemental metal electrodes (opaque or transparent) that contain silver, aluminum, copper, nickel, gold, zinc, cadmium, magnesium, tin, indium, tantalum, titanium, zirconium, cerium, silicon, lead, palladium, or alloys thereof. Metal electrodes on plastic film have the advantage of higher conductivity than ITO electrodes on film.

The alignment coatings 26 and 36 cause a desired orientation of the liquid crystal material 16 at its interface with the panels 12 and 14. This ensures that the liquid crystal rotates light through angles that are complementary to the alignment of the polarizers that may be associated with the cell. The display 10 may include polarizing elements, depending on the type of display (the type of liquid crystal material utilized).

The alignment compositions may include a variety of well-known polymeric materials, for example a polyimide which can be spin coated or printed from solvent, and (if necessary) rubbed with cloth, such as velvet, to provide a useful alignment layer.

The barrier layer 42 prevents moisture and oxygen from being transported through the display. The barrier layer 42 functions to protect layers underneath from environmental damage caused by exposure to oxygen and/or water. In addition, the barrier layer 42 may also function as an adhesion promoter. As the LCD cell gap shrinks, the requirement in barrier performance increases because ingress of fewer water molecules will result in formation of undesirable black spots in the display. The moisture and oxygen barrier may be a conventional suitable material, such as SiO2. Alternatively, the barrier may be SiOx, where 1<x<2. Using SiOx instead of SiO2 may provide an additional moisture and oxygen barrier for the display 10, better preventing moisture and oxygen from being transported through the display. The value x for the SiOx may be controlled, for example, by controlling the oxide ratio in the material used in sputtering the oxide layer, by adding oxygen to an SiO material.

It will be appreciated that the materials for the front substrate 22 and/or the back substrate 32 may be selected to act on their own as a suitable moisture and oxygen barrier. Thus the need for a separate moisture and oxygen barrier may be avoided entirely. For example, a glass front substrate may be sufficiently impermeable to moisture and oxygen to function on its own as a barrier.

The front substrate 22 may have an organic coating thereupon to facilitate adhesion of the sealant ring 30. The sealant ring 30 may be made of a conventional suitable sealant material which may be used for containing the liquid crystal material 16 between the front panel 12 and the back panel 14. It will be appreciated that the sealant ring 30 may alternatively be a part of the back panel 14, if desired. The liquid crystal material 16 may be placed between the panels 12 and 14 prior to the joining of the panels, for example by printing the liquid crystal material on either of the panels. Another method is a dispensing method, in which exact amount of liquid crystal is dispensed on to the substrate before joining two panels. Alternatively, the liquid crystal material 16 may be placed between the panels 12 and 14 after to the joining of the panels 12 and 14, for example by filling the space between the panels through a gap in the sealant ring 30, the gap in the sealant ring subsequently being plugged or otherwise blocked.

In order to allow the preparation of large area displays with uniform spacing and resulting appearance the front panel 12 and/or the back panel 14 may include protrusions and/or other spacers to maintain desired spacing between the front substrate 22 and the back substrate 32.

The outer-side protective layer 40 serves to protect the back substrate 32 from damage and to give dimensional stability to the film. The protective layer 40 may be a copper or aluminum foil, for example. In embodiments for which the back substrate 32 is transparent and the opaque layer 44 is eliminated, a metal protective layer may also function as a reflective layer. The protective layer also serves as a moisture and oxygen barrier. The protective layer may be a metallic film or a film-foil laminate.

The internal protective layer 46 may be an acrylic hard coat layer. As described in further detail below, laser light such as excimer laser light may be used to pattern the back electrodes 34. The internal protective layer 46 may protect laser light penetrating and damaging functional layers (such as the opaque material layer 44 and the barrier layer 42) between the internal protective layer 46 and the back substrate 32. Acrylic, like other organic polymers, has a relatively low thermal conductivity, thereby minimizing lateral damage in ablation that may accompany the laser ablation to pattern the back electrodes 34. It will be appreciated that other suitable materials, such as other suitable polymers, may alternatively be included in the internal protective layer 46.

An opaque substrate and/or electrode material may be used for display devices where light is not transmitted therethrough, but is either reflected by the liquid crystal material or is absorbed by the opaque substrate and/or electrode material. An exemplary suitable liquid crystal material for such a display is a zero field multistable cholesteric liquid crystal mix, such as that described in above-referenced U.S. Pat. No. 5,889,566. Displays including zero field multistable liquid crystal display (FMLCD) technology have many advantages, such as inherent stability in the display without the need to refresh the display, thus allowing a display that can maintain an image in a no-power mode; excellent sunlight readability; and fast switching operation, for example on the order of 30 milliseconds per frame; and the ability to display various gray scales.

The typical LCD panel uses matrix addressing to apply the electric field to an array of LCD elements one row at a time. Appropriate voltages are applied to the crystal cells, causing those desired to be in an On-state to line up. A row is enabled to accept display information in parallel via column line. The electronics performing the matrix addressing proceeds through the rows, serving the same purpose as a vertical deflection amplifier of a cathode ray tube. The matrix addressing used in prior art LCDs then refreshes the display repeating the appropriate voltages to maintain the display or changing the voltage to allow different LCD elements in the array to be on/off. In a matrix addressed display, there is a top sheet with conductive rows, a bottom sheet with conductive electrode columns perpendicular to the top sheet conductive electrode rows. The overlapping point vertically provides the location for the applied field to the element/pixel. The voltage applied between the top sheet location and the bottom sheet location provides the field to drive the crystal behavior of the cell/element/pixel therebetween.

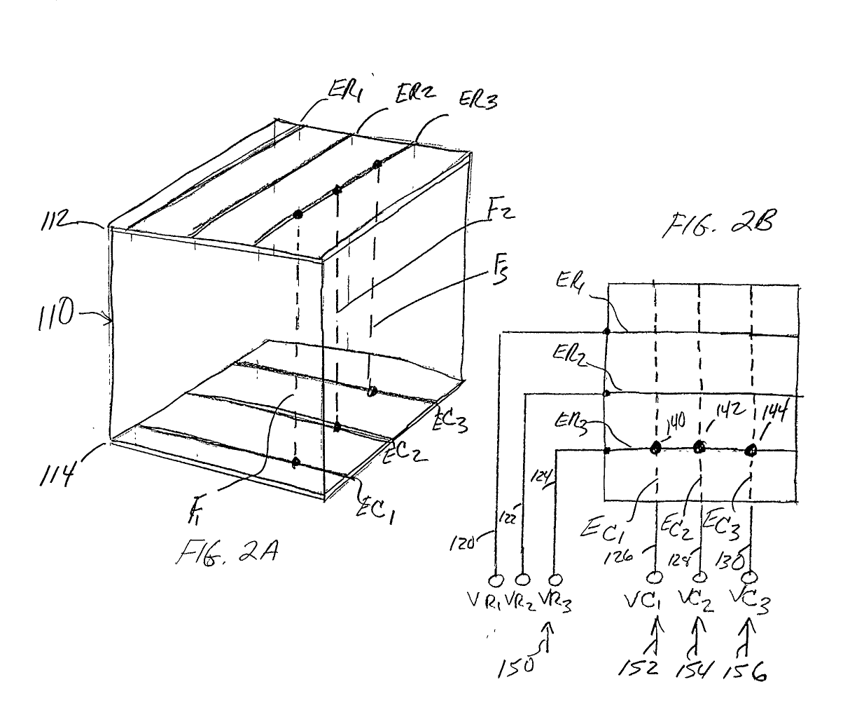

Referring to FIGS. 2A and 2B, a depiction of matrix addressing of a simplified LCD structure is provided. In perspective view FIG. 2A, LCD 110 is situated between substrates 112, 114. Located on substrate 112 is a simplified three electrode row structure having electrode rows Er₁, Er₂, Er₃. Located on substrate 114 is a simplified three electrode column structure having electrode columns Ec₁, Ec₂, Ec₃. A voltage applied to respective electrode rows and electrode columns create an electric field in the LCD therebetween. For example, a voltage applied to electrode row Er3 and electrode column Ec₁ will create electric field F₁. A voltage applied to electrode row Er₃ and electrode column Ec₂ will create electric field F₂. A voltage applied to electrode row Er3 and electrode column Ec₃ will create electric field F₃. Referring to FIG. 2B, a top view of the structure shown in FIG. 2A is depicted. Electrode rows Er₁, Er₂, Er₃ have conventional leads 120, 122, 124 connected thereto to allow matrix addressing voltages to be applied at respective ports Vr1, Vr2, Vr3. Electrode columns Ec₁, Ec₂, Ec₃ have conventional leads 126, 128, 130 connected thereto to allow matrix addressing voltages to be applied at respective ports Vc₁, Vc₂, Vc₃. Therefore, when a desired dark surface (blocked reflection) is to be viewed at points 140, 142 and 144, matrix addressing voltages 150, 152, 154, 156 would be appropriately applied to ports Vr₃, Vc₁, Vc₂, Vc₃.

However, because the bi-stable nature of the cholesteric LCD causes the LCD element to remain in one state after the applied field is removed, in accordance with the present invention refreshing is not needed to maintain the display until it is desired that the display element be changed. Each of the rows are scanned once with an appropriately timed voltage applied to the desired element/pixel. Refreshing is not needed.

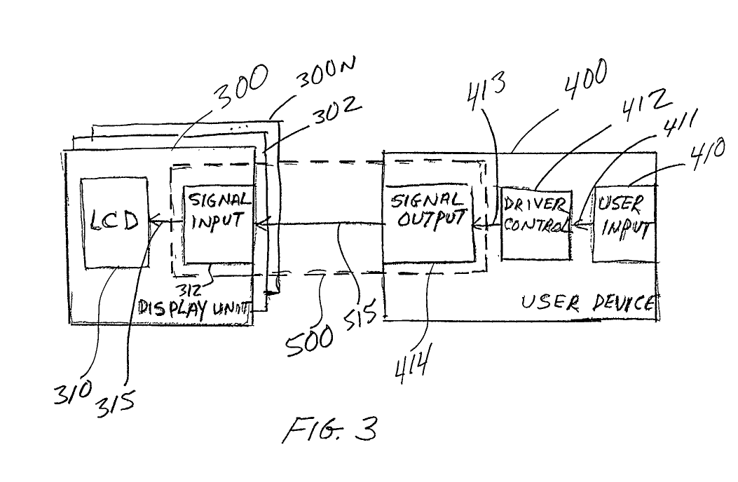

Referring to FIG. 3, there is depicted in simplified block diagram form an embodiment of the present invention wherein LCD display units 300, 302, . . . 300n are controlled by user device 400 through signal interface 500. Each display unit includes its respective LCD 310 responsive to an electric voltage applied thereto through signal input portion 312 of signal interface 500. User device 400 includes user input 410 which applies input control signals 411 to driver control 412 which, in turn, applies driver control signals 413 to signal output portion 414 of signal interface 500. User device 400, in accordance with one embodiment of the present invention, is a portable hand-held device useable by a store employee, for example, wishing to change one or more display units 300 . . . 300n located on shelves throughout the store. User input 410 is typically a key pad for manually entering desired display information to be displayed by LCD 310. Driver control 412 is responsive to user input 410 to convert, e.g., key pad entries into appropriate matrix addressing voltages to be conveyed to a specific display unit 300 through signal interface 500. Driver control 412 provides driver control signals 413 to signal output 414 which provides the means for transmitting 515 the driver control signals, i.e., voltages for addressing the rows and columns on the sheets by applying the appropriate voltage to the respective electrodes, to the display unit 300 depending on the nature of signal interface 500 as described below. Of particular note in accordance with the present invention is that signal input 312 of display unit 300 contains the minimal amount of circuitry needed to receive driver control signals to effectuate applying appropriate matrix addressing voltages to LCD 310, a bistable LCD such as a cholesteric LCD.

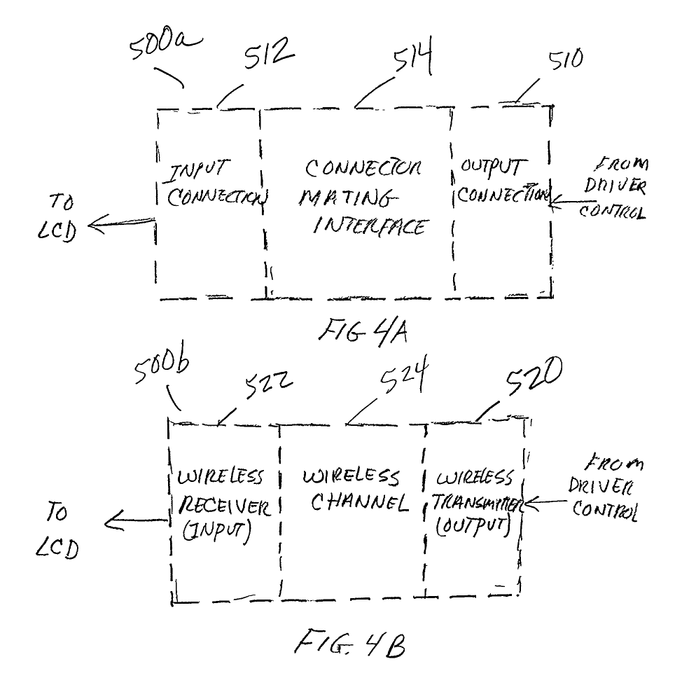

Referring now to FIGS. 4A and 4B variations 500a and 500b of signal interface 500 shown in FIG. 3 are depicted. In FIG. 4A, signal interface 500a is a physical mating connector, a portion of which, namely output connection 510, is located on user device 400, and another portion of which, namely input connection 512, is located on each display unit 300 . . . 300n. Output connection 510 could be a multi-pin or multi-pad connector which is responsive to driver control signal voltages applied from driver control 412. Input connection 512 could be a respective mating multi-pin or multi-pad connector when joined to form a connector junction 514 allowing the driver control voltages to be transferred from hand-held user device 400 to shelf display unit 300. In turn, the received driver control voltages from the multi-pin connector of input connection 512 are then applied through appropriate leads 315 to the electrodes of LCD 310 interconnected to input connection 512 as described above in conjunction with FIG. 2. Of particular note is that in accordance with the present invention display units 300 . . . 300n do not contain any driver control processing devices located thereon, merely a connection interface and the LCD being driven. Such minimal amount of components being located on the display unit provides an exceptionally low cost display unit which can be driven by a single portable user device as compared to prior art displays which integrate drive control microprocessors with each LCD display.

Referring now to FIG. 4B, signal interface 500b is a wireless transmission system, a portion of which, namely, wireless transmitter output 520, is located on user device 400, and another portion of which, namely wireless receiver input 522, is located on each display unit 300 . . . 300n. Wireless transmitter output 520 could be a wireless radio frequency (RF), infrared (IR) or audio responsive to driver control signals 413 applied from driver control 412. Wireless receiver input 522 could be a respective RF, IR or audio receiver located on each display unit 300 . . . 300n which allows the driver control voltages to be transferred from hand-held user device 400 to display unit 300 through wireless channel 524, such as the atmosphere. In turn, the received driver control voltages from the wireless receiver 522 of signal input 312 are then applied through appropriate leads 315 to the electrodes of LCD 310 interconnected to wireless receiver 522. Of particular note is that in accordance with the present invention display units 300 . . . 300n do not contain any driver control processing devices located thereon, merely an RF, IR or audio receiver and the LCD being driven therefrom. As with the embodiment depicted in FIG. 4A, such minimal amount of circuitry/components being located on the display unit in accordance with the embodiment depicted in FIG. 4B provides an exceptionally low cost display unit which can be driven by a single portable user device as compared to prior art displays which integrate drive control microprocessors with each LCD display.

The application of the electric field to the appropriate LCD elements to perform the driver control/matrix addressing can provided by common microcontroller chips along with corresponding software. Theses microcontroller chips and software in accordance with the present invention are notably not located in the display unit, but rather in the user device.

By not having the driver, controller and power source integrated with the LCD display panel, much of the cost of individual panels as compared to the prior art is significantly reduced. This can be particularly significant where there are hundreds of product displays in a typical store. In accordance with the present invention, by utilizing a cholesteric LCD display having its driver, controller, user interface remote therefrom, the display panel can be greatly simplified. Each display panel would not require its own driver, controller. The driver, controller and output interface can be included in a single user device which would function in conjunction with each of the various display panels which merely a corresponding input interface and the LCD itself. Further, the cholesteric LCD display can simplify the user device in that constant refresh circuitry is not needed to keep the LCD in its desired state.

Also, rather than having a portable remote user device, such user device could be configured as a centralized computer terminal user device.

The present invention has other potential embodiments. For example a removable shelf display could be inserted into a reader, updated by the user device and reinstalled on its shelf after the cholesteric LCD is set to the On-state. The reader could include contact pads whereupon the removable shelf device would have mating contact pads when installed in the reader to allow the user device (reader) to send the appropriate voltages to the display unit be updated.

Such usage of a cholesteric LCD in a panel is not limited to shelf displays as has been described above. The cholesteric LCD could be installed on devices such as a smart card having a display panel and appropriate input interface.

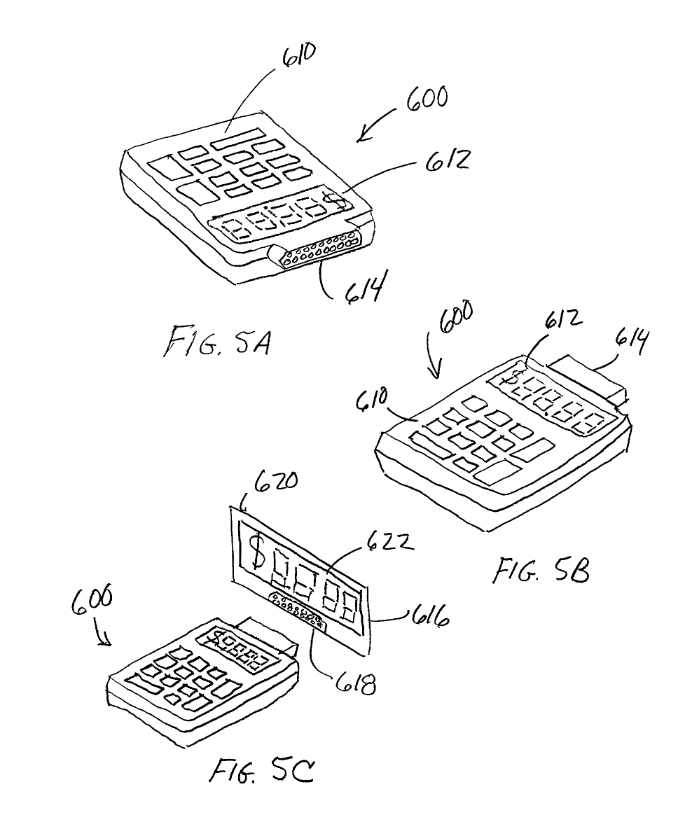

Referring to FIGS. 5A-5C, an embodiment of the present invention involving connector contacts is depicted.

In FIG. 5A hand held input device 600 is shown. This device would contain a power source (battery not shown), keypad 610, display 612, spring loaded connecting pins 614 and the necessary electronics (not shown) to “write” to the display.

In FIG. 5B, the hand held input device 600 is shown wherein the operator has input using the keypad the desired number (e.g., $88.88). This number is shown on display window 612 of hand held input device 600.

In FIG. 5C, displayed are both hand held input device 600 and LCD display panel 616. The LCD display panel 616 has contacts 618, bezel or housing 620 to protect and mount display window 622.

Hand held input device 600 would engage LCD display panel 616 by the mating of connecting pins 614 of hand held input device 600 with contacts 618 on LCD display panel 616. Once the hand held input device is placed in contact with the display an “ENTER” button on the input device is pressed. This sends the “write” signals to the display. Alternatively, the contacts could activate a micro-switch inside the input device, and when full compressed sending the “write” signals. Once the image is transferred to the LCD display panel, the input device can be removed and used to “write” to the next display panel.

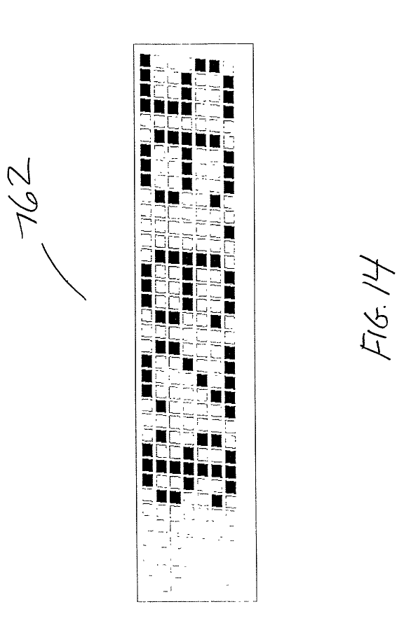

Referring to FIG. 13 there is shown typical LCD display 760 with the bezel removed. The display is composed of two sheets of film or glass, each with an etched transparent conductive layer. Micro-sphere and seal ring 761 separate the two layers. The space between is filled with liquid crystal. Metal contacts or bumps 764 are adhered to traces 766, (bump on flex) with conductive adhesive or anisotropic conductive film. These metal “bumps” provide a robust interface for the input device. The same conductive material would be used at crossover point 768 to electrically connect the top and bottom layers. Top film cutout 770 is provided for access to the display contacts.

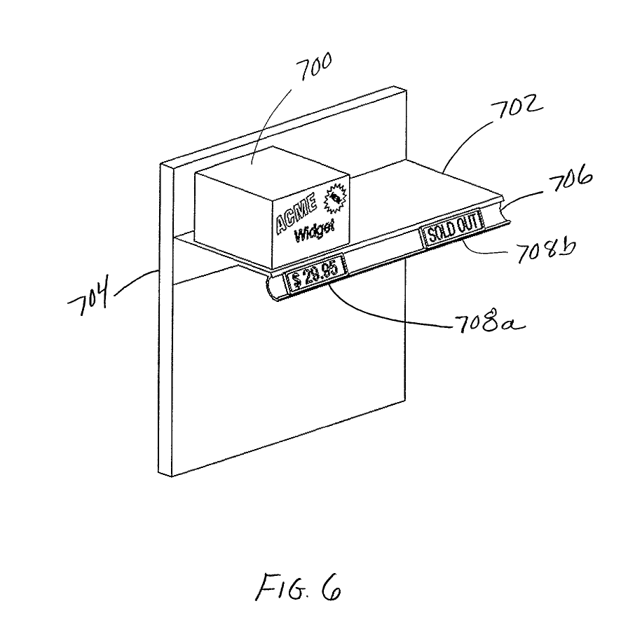

Referring now to FIG. 6, a typical simplified commercial product display and its product display signage is depicted which can make use of the present invention. Product 700 is situated on shelf 702 of product stand 704. Product shelf 702 has a shelf extension 706 wherein product display signages 708a, 708b can be located. Signage 708a associated with product 700 can be different from signage 708b which is associated with a “sold out” adjacent product and which is below an empty shelf area, even though the respective signages are located on the same shelf extension 706.

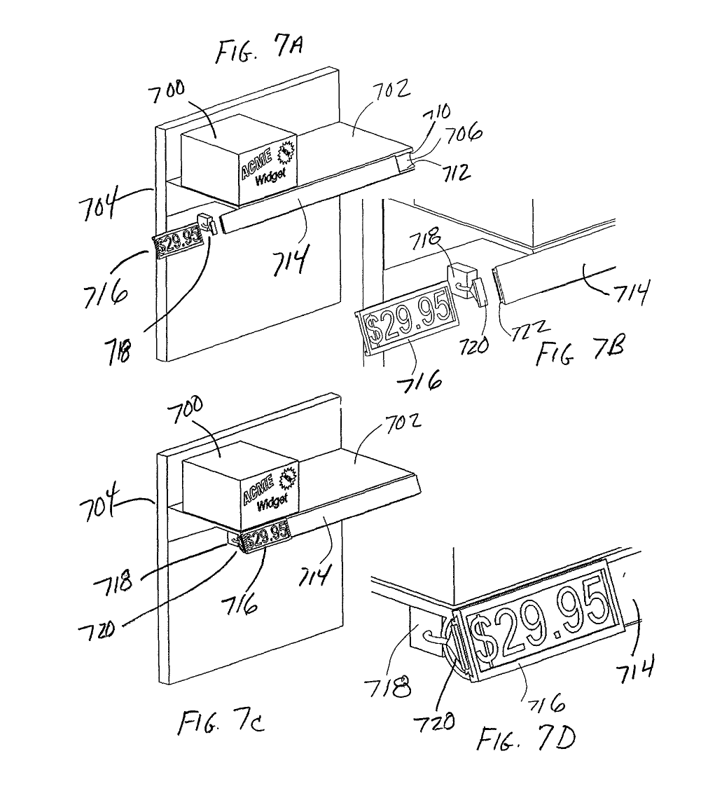

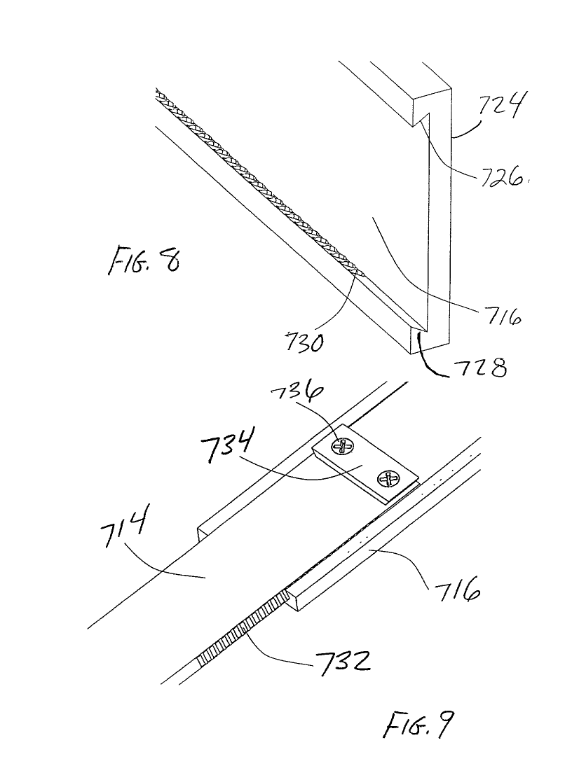

Referring to FIGS. 7A-7D, an exemplary embodiment utilizing the bistable cholesteric LCD display panel in accordance with the present invention implemented in conjunction with the simplified commercial product display of FIG. 6 is shown. FIG. 7A shows an exploded view of an implementation of the present invention, with FIG. 7B showing a close-up portion thereof. FIGS. 7C and 7D show non-exploded views of such implementation.

Shelf 702 has shelf extension 706 with a recessed channel. The recessed channel has an upper channel lip 710 and a lower channel lip 712 to which display rail 714 can be mounted. Display rail 714 provides a mounting location for the LCD panel display assembly 716, such as a bistable cholesteric LCD display panel herein above-described. Display rail 714 also serves as an electrical interconnect between the LCD display assembly 716 and display controller 718. Display controller 718 is connected to display rail 714 by modular plug 720 inserted into controller plug receptacle 722 on ether end of display rail 714.

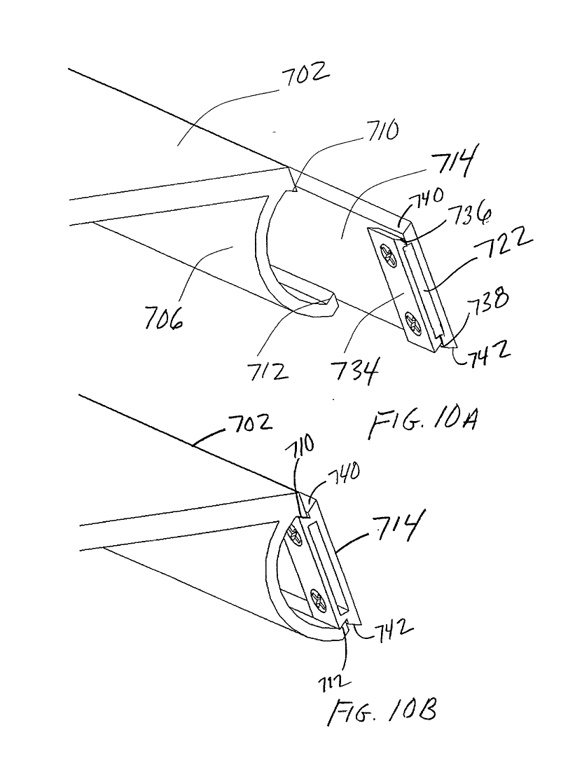

Referring now to FIGS. 8 and 9, the rear of LCD display panel 716, which is opposite display face 724, includes upper dove-tail slide 726 and lower dove-tail slide 728. Spring wire contacts 730 are located on lower dove-tail slide 728. In FIG. 9, display rail 714 is shown having mating contacts 732. The pitch and number of mating contacts 732 match those of the spring wire contacts 730 on LCD display assembly 716. Display rail 714 also includes mounting bracket 734. Mounting bracket 734 is shown attached with screw fasteners 736, however it could very well be attached with mechanical clips or adhesive. The use of an attachable mounting bracket 734 rather than one molded in to the display rail 714 simplifies the design lowering manufacturing cost. This feature enables this unit to be used on shelves 702 of various design and manufacture by simply changing mounting bracket 734 to one suitable to mount on that particular shelf design.

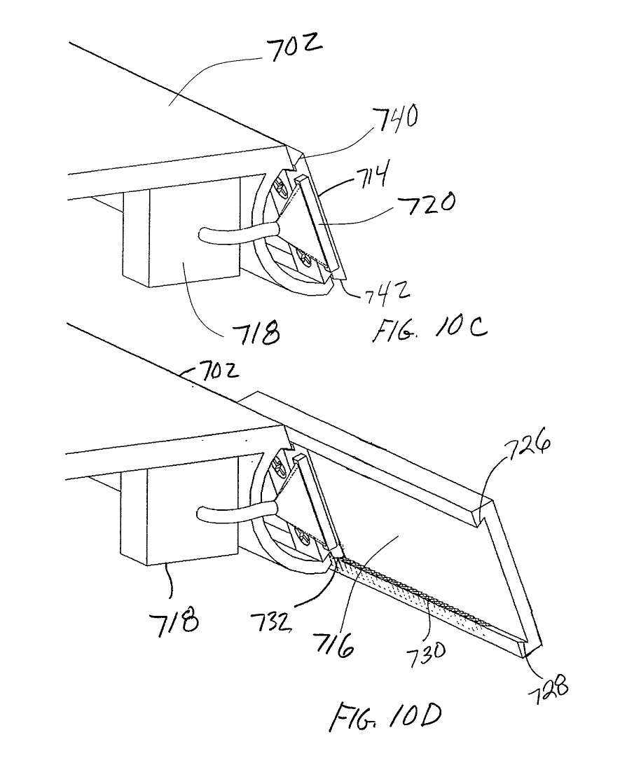

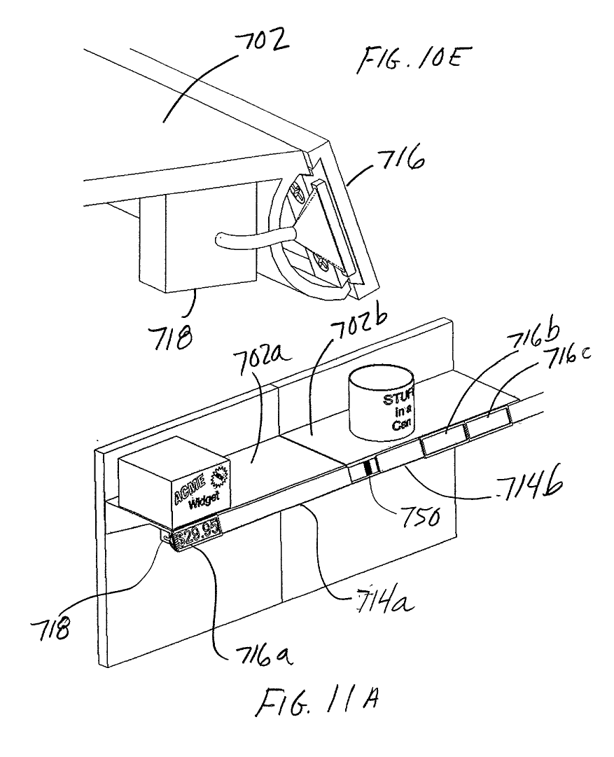

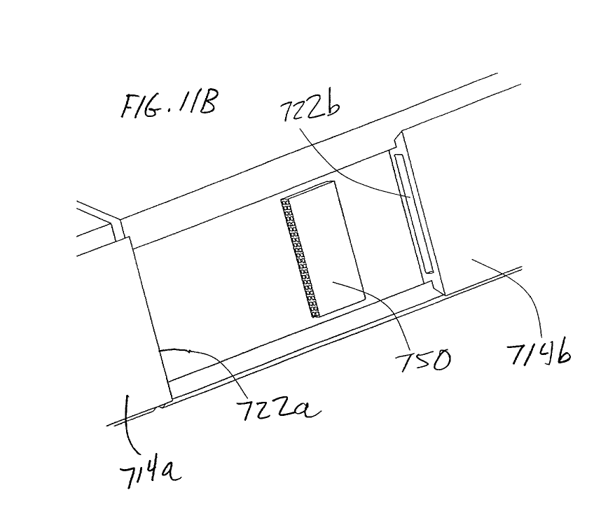

Referring to FIGS. 10A-10E, the assembly sequence for the LCD panel display assembly onto shelf 702 is shown. In FIGS. 10A and 10B the installation of display rail 714 onto the shelf extension 706 is seen. Mounting bracket 734 includes dove-tail grooves 736, 738 which engage respectively upper channel lip 710 and lower channel lip 712 the channel lips as a dovetail as seen in FIG. 10B. Display rail 714 includes receptacle 722 leading to internal wiring (not shown) within display rail 714 for providing appropriate contacts to LCD display panel circuitry as described above. Display rail 714 also includes upper display rail slide 740 and lower display rail slide 742. In FIG. 10C, display controller 718 is shown mounted onto the lower surface of shelf 702. Modular connector 720 connects to receptacle 722. In FIGS. 10D and 10E, LCD display panel 716 is mounted onto display rail 714 by having upper dove-tail slide 726 and lower dove-tail slide 728 slidably engage respectively upper display rail slide 740 and lower display rail slide 742. Spring wire contacts 730 mate with mating contacts 732 such than LCD display panel 716 is in electrical connection with display controller 718. In accordance with embodiment LCD display assembly 716 can be installed on the display rail 714 at any point along the rail and with out removing any previously installed display assemblies by providing appropriate detents/stops to allow spring wire contacts 730 to correctly align with corresponding mating contacts 732.

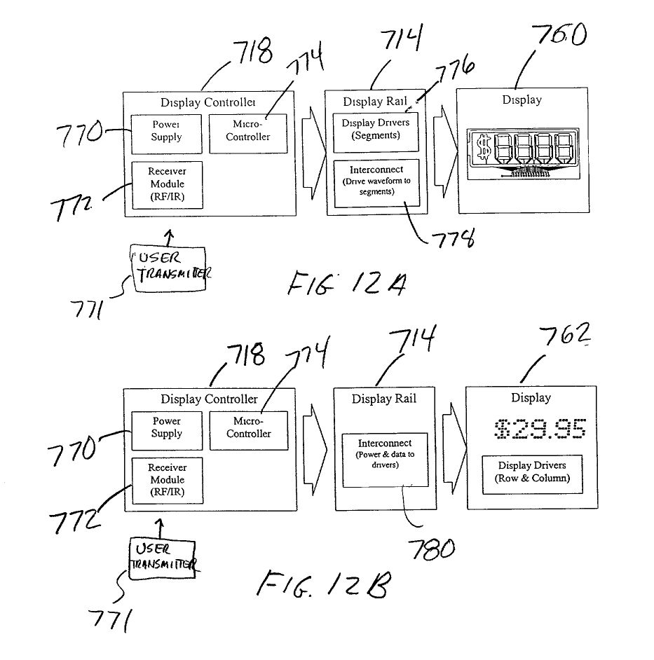

Referring now to FIGS. 11A-11B, another exemplary embodiment of the present invention is shown wherein the display rails can be linked together to drive many LCD displays, such as the bistable cholesteric LCD displays herein above-described, using the same display controller. For example, a shelf 702a can be adjacent a shelf 702b. Shelf 702a can have its LCD panel display assembly 714a mounted on its display rail 714a, while adjacent shelf 702b can have its adjacent LCD panel display assemblies 716b, 716c mounted on its display rail 714b. Modular inter-rail connector 750 is inserted into receptacles 722a and 722b between and interconnecting the two display rails. Further inter-rail connectors can allow multiple display rails to be joined together in series, as desired. When the display rails are brought together in this manner, power and data can be sent the entire length of the rails.

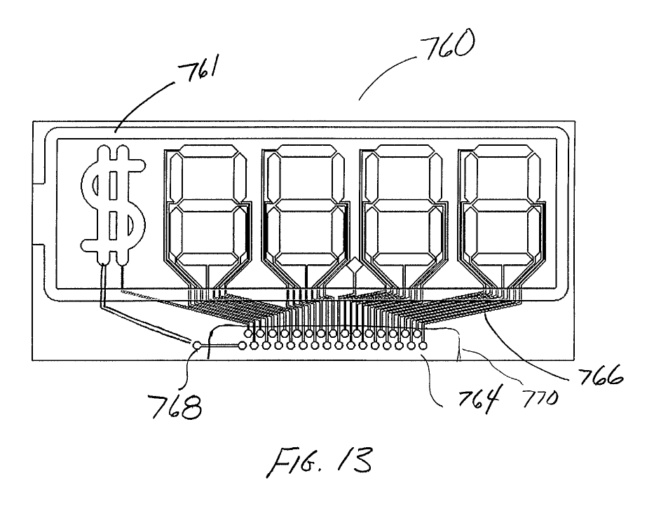

Referring now to FIGS. 12A and 12B, there is depicted the relationships and processing for the shelf mounted displays described in conjunction with embodiments shown in FIGS. 6-11B. In FIG. 12A, display controller 718 is shown communicating with display rail 714, which in turn communicates with a segmented LCD display 760, the display face of which is shown in FIG. 13. Display controller 718 would typically include power supply 770, RF/IR receiver module 772 and microcontroller 774. RF/IR receiver module 772 would be responsive to signals transmitted by user transmitter 771. Display rail 714 would include segment display drivers and appropriate interconnect circuitry to drive the appropriate waveforms to the respective segment. In FIG. 12B, display controller 718 is shown communicating with display rail 714, which in turn communicates with a matrix display 762, the display face of which is shown in FIG. 14. In th FIG. 12B embodiment, display controller 718 would be similar to that of FIG. 12A. However, display rail 714 would have interconnect circuitry 780 for providing power and data to row and column display drivers located on matrix display 762. In addition, those skilled in the art can appreciate that the LCD assembly, while being mounted on a display rail can alternatively receive inputs utilizing the manual connection approach depicted in FIGS. 5A 5C rather than utilizing the display controller to receive wireless transmitted information.

Therefore, in accordance with the present invention, a simple cost-effective electronic display unit and related implementation system has been provided, including a display unit which has greatly reduced power needs on the display unit thereby providing the ability to have lower priced individual display units.

1. A method of displaying information by a liquid crystal display comprising:
coupling a bistable liquid crystal display to a signal input to provide a display device;
providing a user device remote from the display device for controlling the bistable liquid crystal display, the user device having a signal output coupled to a driver control, the driver control being responsive to a user input controlled by a user to display the information by the liquid crystal display; and
electrically interconnecting the display device with the user device by coupling the signal output to the signal input through a signal interface.

2. The method of claim 1, wherein the bistable liquid crystal display is a cholesteric liquid crystal display.

3. The method of claim 1 wherein the driver control provides matrix addressing signals to the bistable crystal display in response to the user input.

4. The method of claim 1 wherein the user device is a hand held device and the user input is a keypad.

5. The method of claim 1 wherein the signal input is a first connector, the signal output is a second connector and the signal interface is a connector mating interface, and electrically interconnecting the display device with the user device is by mating the first connector with the second connector at the connector mating interface such that driver control signals from the driver control are provided to the liquid crystal display through a mated connection of the first connector with the second connector.

6. The method of claim 1, wherein the signal input is a wireless receiver, the signal output is a wireless transmitter and the signal interface is a transmission medium, and the electrically interconnecting the display device with the user device is by transmitting by the wireless transmitter driver control signals from the driver control over a transmission medium to the wireless receiver coupled to the liquid crystal display.

7. The method of claim 6, wherein the wireless transmitter and wireless receiver respectively transmit and receive radio frequency signals.

8. The method of claim 6, wherein the wireless transmitter and wireless receiver respectively transmit and receive infrared signals.

9. The method of claim 6, wherein the wireless transmitter and wireless receiver respectively transmit and receive audio signals.

10. A method of displaying information by a liquid crystal display comprising:
coupling a cholesteric liquid crystal display to a signal input to provide a display device;
providing a hand-held user device remote from the display device for controlling the cholesteric liquid crystal display, the hand-held user device having:
a signal output coupled to a driver control, and
keypad user input coupled to the driver control, the driver control providing matrix addressing signals in response to the user input being controlled by a user to display the information by the cholesteric liquid crystal display; and
electrically interconnecting the display device with the hand-held user device for providing the matrix addressing signals to the cholesteric crystal display by coupling the signal output to the signal input through a signal interface.

11. The method of claim 10, wherein the signal input is a first connector, the signal output is a second connector and the signal interface is a connector mating interface, and electrically interconnecting the display device with the user device is by mating the first connector with the second connector at the connector mating interface such that the matrix addressing signals from the driver control are provided to the cholesteric liquid crystal display through a mated connection of the first connector with the second connector.

12. The method of claim 10, wherein the signal input is a wireless receiver, the signal output is a wireless transmitter and the signal interface is a transmission medium, and the electrically interconnecting the display device with the user device is by transmitting by the wireless transmitter matrix addressing signals from the driver control over a transmission medium to the wireless receiver coupled to the cholesteric liquid crystal display.

13. A liquid crystal display apparatus for displaying information comprising:
a bistable liquid crystal display coupled to a signal input to provide a display device;
a user device remote from the display device for controlling the bistable liquid crystal display, the user device having a signal output coupled to a driver control, the driver control being responsive to a user input controlled by a user to display the information by the liquid crystal display, the display device being electrically interconnected with the user device by coupling the signal output to the signal input through a signal interface.

14. The liquid crystal display apparatus of claim 13, wherein the bistable liquid crystal display is a cholesteric liquid crystal display.

15. The liquid crystal display apparatus of claim 13, wherein the driver control provides matrix addressing signals to the bistable crystal display in response to the user input.

16. The liquid crystal display apparatus of claim 13, wherein the user device is a hand held device and the user input is a keypad.

17. The liquid crystal display apparatus of claim 13, wherein the signal input is a first connector, the signal output is a second connector and the signal interface is a connector mating interface, and the display device is electrically interconnected with the user device is by mating the first connector with the second connector at the connector mating interface such that driver control signals from the driver control are provided to the liquid crystal display through a mated connection of the first connector with the second connector.

18. The liquid crystal display apparatus of claim 13, wherein the signal input is a wireless receiver, the signal output is a wireless transmitter and the signal interface is a transmission medium, and the display device is electrically interconnected with the user device is the transmission by the wireless transmitter driver control signals from the driver control over a transmission medium to the wireless receiver coupled to the liquid crystal display.

19. The liquid crystal display apparatus of claim 18, wherein the wireless transmitter and wireless receiver respectively transmit and receive radio frequency signals.

20. The liquid crystal display apparatus of claim 18, wherein the wireless transmitter and wireless receiver respectively transmit and receive infrared signals.

21. The liquid crystal display apparatus of claim 18, wherein the wireless transmitter and wireless receiver respectively transmit and receive audio signals.

22. A liquid crystal display apparatus comprising:
a cholesteric liquid crystal display coupled to a signal input to provide a display device;
a hand-held user device remote from the display device for controlling the cholesteric liquid crystal display, the hand-held user device having:
a signal output coupled to a driver control, and
a keypad user input coupled to the driver control, the driver control providing matrix addressing signals in response to the user input being controlled by a user to display the information by the cholesteric liquid crystal display, the display device being electrically interconnected with the hand-held user device for providing the matrix addressing signals to the cholesteric crystal display by coupling the signal output to the signal input through a signal interface.

23. The liquid crystal display apparatus of claim 22, wherein the signal input is a first connector, the signal output is a second connector and the signal interface is a connector mating interface, and electrically interconnecting the display device with the user device is by mating the first connector with the second connector at the connector mating interface such that the matrix addressing signals from the driver control are provided to the cholesteric liquid crystal display through a mated connection of the first connector with the second connector.

24. The liquid crystal display apparatus of claim 22, wherein the signal input is a wireless receiver, the signal output is a wireless transmitter and the signal interface is a transmission medium, and the electrically interconnecting the display device with the user device is by transmitting by the wireless transmitter matrix addressing signals from the driver control over a transmission medium to the wireless receiver coupled to the cholesteric liquid crystal display.

25. A method of displaying information by a liquid crystal display comprising:
mounting a display rail to a product shelf, the display rail being adapted for removably mounting thereon a bistable liquid crystal display;
mounting a display controller to the product shelf, the display controller being responsive to a user input controlled by a user to display information by the bistable liquid crystal display; and
electrically interconnecting the display controller to the display rail to provide display control information to the bistable liquid crystal display.

26. The method of claim 25, wherein the bistable liquid crystal display is a bistable cholesteric liquid crystal display.

27. The method of claim 25, wherein the bistable liquid crystal display is a segmented display.

28. The method of claim 25, wherein the bistable liquid crystal display is a matrix display.

29. The method of claim 25, wherein the display controller provides matrix addressing signals to the bistable liquid crystal display in response to the user input.

30. The method of claim 25, wherein the display controller input is a wireless receiver.

31. The method of claim 30, wherein the wireless receiver receives radio frequency signals.

32. The method of claim 30, wherein the wireless receiver receives infrared signals.

33. The method of claim 25, wherein the bistable liquid crystal display is mounted on the display rail such that display rail electrical contacts mate with bistable liquid crystal display electrical contacts.

34. The method of claim 25, wherein the bistable liquid crystal display is slidably mounted on the display rail.

35. A method of displaying information by a plurality of liquid crystal displays comprising:
mounting a plurality of display rails to a product shelf, each display rail being adapted for removably mounting thereon a one or more bistable liquid crystal displays;
mounting a display controller to the product shelf, the display controller being responsive to a user input controlled by a user to display information by the bistable liquid crystal displays; and
electrically interconnecting the display controller to each display rail through one or more display rail electrical interconnectors to provide display control information to each bistable liquid crystal display.

36. The method of claim 35, wherein the bistable liquid crystal displays are bistable cholesteric liquid crystal displays.

37. The method of claim 35, wherein the bistable liquid crystal displays are segmented displays.

38. The method of claim 35, wherein the bistable liquid crystal displays are matrix displays.

39. The method of claim 35, wherein the display controller provides matrix addressing signals to the bistable liquid crystal displays in response to the user input.

40. The method of claim 35, wherein the display controller input is a wireless receiver.

41. The method of claim 40, wherein the wireless receiver receives radio frequency signals.

42. The method of claim 40, wherein the wireless receiver receives infrared signals.

43. The method of claim 35, wherein the bistable liquid crystal displays are mounted on the display rails such that display rail electrical contacts mate with corresponding bistable liquid crystal display electrical contacts.

44. The method of claim 35, wherein the bistable liquid crystal displays are slidably mounted on the display rails.

45. A liquid crystal display apparatus comprising:
a display rail adapted for mounting to a product shelf, the display rail being adapted for removably mounting thereon a bistable liquid crystal display; and
a display controller mounted to the product shelf, the display controller being responsive to a user input controlled by a user to display information by the bistable liquid crystal display and being electrically interconnected to the display rail to provide display control information to the bistable liquid crystal display.

46. The liquid crystal display apparatus of claim 45, wherein the bistable liquid crystal display is a bistable cholesteric liquid crystal display.

47. The liquid crystal display apparatus of claim 45, wherein the bistable liquid crystal display is a segmented display.

48. The liquid crystal display apparatus of claim 45, wherein the bistable liquid crystal display is a matrix display.

49. The liquid crystal display apparatus of claim 45, wherein the display controller provides matrix addressing signals to the bistable liquid crystal display in response to the user input.

50. The liquid crystal display apparatus of claim 45, wherein the display controller input is a wireless receiver.

51. The liquid crystal display apparatus of claim 50, wherein the wireless receiver receives radio frequency signals.

52. The liquid crystal display apparatus of claim 50, wherein the wireless receiver receives infrared signals.

53. The liquid crystal display apparatus of claim 45, wherein the bistable liquid crystal display is mounted on the display rail such that display rail electrical contacts mate with bistable liquid crystal display electrical contacts.

54. The liquid crystal display apparatus of claim 45, wherein the bistable liquid crystal display is slidably mounted on the display rail.

55. A liquid crystal display apparatus of displaying information by a plurality of bistable liquid crystal displays comprising:
a plurality of display rails mounted to a product shelf, each display rail being adapted for removably mounting thereon one or more bistable liquid crystal display;
a display controller mounted to the product shelf, the display controller being responsive to a user input controlled by a user to display information by the bistable liquid crystal displays and being electrically interconnected to each display rail through one or more display rail electrical interconnectors to provide display control information to each bistable liquid crystal display.

56. The liquid crystal display apparatus of claim 55, wherein the bistable liquid crystal displays are bistable cholesteric liquid crystal displays.

57. The liquid crystal display apparatus of claim 55, wherein the bistable liquid crystal displays are segmented displays.

58. The liquid crystal display apparatus of claim 55, wherein the bistable liquid crystal displays are matrix displays.

59. The liquid crystal display apparatus of claim 55, wherein the display controller provides matrix addressing signals to the bistable liquid crystal displays in response to the user input.

60. The liquid crystal display apparatus of claim 55, wherein the display controller input is a wireless receiver.

61. The liquid crystal display apparatus of claim 60, wherein the wireless receiver receives radio frequency signals.

62. The liquid crystal display apparatus of claim 60, wherein the wireless receiver receives infrared signals.

63. The liquid crystal display apparatus of claim 55, wherein the bistable liquid crystal displays are mounted on the display rails such that display rail electrical contacts mate with corresponding bistable liquid crystal display electrical contacts.

64. The liquid crystal display apparatus of claim 55, wherein the bistable liquid crystal displays are slidably mounted on the display rails.
